(19) United States
(12) Patent Application Publication
(10) Pub. No.: US 2023/0139155 A1
(43) Pub. Date: May 4, 2023

(54) OPTICAL RECEIVING APPARATUS AND LIGHT DETECTION AND RANGING SYSTEM

(71) Applicant: HUAWEI TECHNOLOGIES CO., LTD., Shenzhen (CN)

(72) Inventors: Kai AN, Shanghai (CN); Yilun ZHOU, Shanghai (CN); Yun DING, Wuhan (CN)

(21) Appl. No.: 18/147,242

(22) Filed: Dec. 28, 2022

Related U.S. Application Data
(63) Continuation of application No. PCT/CN2021/082359, filed on Mar. 23, 2021.

(30) Foreign Application Priority Data
Jun. 30, 2020 (CN) 202010619749.X

(51) Int. Cl. G01S 17/89; G01S 7/481

(52) U.S. Cl. CPC G01S 17/89; G01S 7/4817; G01S 7/4816

(57) ABSTRACT

This disclosure provides an optical receiving apparatus, including a photodetector and a plurality of beam homogenization units. The photodetector includes a plurality of pixels, each pixel includes a plurality of cells, and the cell is configured to convert a received optical signal into an electrical signal. Each beam homogenization unit corresponds to at least one pixel of the photodetector, and is configured to diffuse a received incident light beam to a plurality of cells included in the corresponding at least one pixel. The optical receiving apparatus may be applied in a light detection and ranging system. The apparatus increases dynamic ranges of the detector and the light detection and ranging system, and improves detection efficiency.

### CROSS-REFERENCE TO RELATED APPLICATIONS

This application is a continuation of International Application No. PCT/CN2021/082359, filed on Mar. 23, 2021, which claims priority to Chinese Patent Application No. 202010619749.X, filed on Jun. 30, 2020. The disclosures of the aforementioned applications are hereby incorporated by reference in their entireties.

### TECHNICAL FIELD

This disclosure relates to the light detection field, and in particular, to an optical receiving apparatus and a light detection and ranging system.

### BACKGROUND

A photodetector may be applied to many fields, for example, may be applied to a receiving apparatus in a light detection and ranging system. An operating principle of the light detection and ranging (LiDAR) system is that a laser beam at a specific frequency is emitted into a specified region, an object is encountered in a laser flying process, the laser beam is reflected on a surface of the object, and some lasers are reflected into a radar receiving apparatus to form an echo. The light detection and ranging receiving apparatus compares a received echo signal and a transmit signal, to obtain related information of the object, for example, a distance, an angle, or reflectivity.

There are a plurality of photodetectors such as an avalanche photodiode (APD), a single photon avalanche diode (SPAD), or a silicon photomultiplier (SiPM). The silicon photomultiplier SiPM includes an avalanche diode array operating in a Geiger mode, and includes a photon counter of a plurality of pixels. One pixel includes a plurality of independent photosensitive units, referred to as a cell, and response signals of the plurality of photosensitive units are accumulated and output through a common output channel. The SiPM has characteristics such as high sensitivity, a low bias voltage, and a compact structure.

When the SiPM is used as an optical receiving detector, because a received optical signal is converged by a receiving lens, the converged optical signal is incident on a small part of a pixel of a photosensitive surface of the SiPM, causing a small dynamic range of the detector and low detection efficiency.

### SUMMARY

Embodiments of this disclosure provide an optical receiving apparatus and a light detection and ranging system, to increase a dynamic range of a detector and the light detection and ranging system, and improve detection efficiency.

According to a first aspect, an embodiment of this disclosure provides an optical receiving apparatus, including a photodetector and a plurality of beam homogenization units. The photodetector includes a plurality of pixels, each pixel includes a plurality of cells, and the cell is configured to convert a received optical signal into an electrical signal. Each beam homogenization unit corresponds to at least one pixel of the photodetector, and is configured to diffuse a received incident light beam to a plurality of cells included in the corresponding at least one pixel. The beam homogenization unit diffuses incident light to a plurality of cells, to increase a dynamic range of the entire detector, and improve detection efficiency.

In a possible design, the beam homogenization unit includes a beam homogenization prism; and a side wall of the beam homogenization prism is coated with a reflective coating, so that the received light beam is diffused to the plurality of cells included in the at least one pixel of the photodetector. The beam homogenization prism is used to evenly diffuse the incident light to a light-emitting surface.

In a possible design, a length L of the beam homogenization prism meets a condition: L≥d/(2*tan(θ/2)), where d is a length of a short side of a light-passing cross section of the beam homogenization prism, and θ is a divergence angle existing when a light beam enters the prism. Such a dimensional characteristic enhances a diffusion effect.

In a possible design, the beam homogenization unit further includes a diffusion sheet, disposed before a light-entrance surface of the beam homogenization prism; and the diffusion sheet is configured to diffuse and output the received incident light beam to the light-entrance surface of the beam homogenization prism. In this case, a beam homogenization effect is further improved.

In a possible design, the beam homogenization unit further includes a microlens, disposed on a light-entrance surface of the beam homogenization unit; and the microlens is configured to converge the received incident light beam on the diffusion sheet or the light-entrance surface of the beam homogenization prism. The microlens is used to enlarge an angle of incidence of the incident light.

In a possible design, components of the beam homogenization unit are connected through bonding by using a photosensitive adhesive. The photosensitive adhesive is used to reduce an energy loss of the incident light.

In a possible design, the photodetector is a silicon photomultiplier (SiPM). The SiPM is used to allow the detector to have higher sensitivity.

In a possible design, a plurality of beam homogenization units are embraced and fastened by using a mechanical part, to improve durability of the optical receiving apparatus.

In a possible design, the beam homogenization unit corresponds to a plurality of pixels, and the plurality of beam homogenization units are a prism without internal isolation, and form a row layout, a column layout, or an irregular-shape layout, so that an application scenario of the optical receiving apparatus is more extensive.

In a possible design, a light-emitting end face of the beam homogenization unit has a same size as a photosensitive surface in the pixel of the detector, to reduce an energy loss of the incident light.

According to a second aspect, an embodiment of this disclosure provides a light detection and ranging system, including a light source, a scanner, a receiving lens, the optical receiving apparatus, and a processor. The light source is configured to output a laser beam. The scanner is configured to perform scanning in a specified region. The receiving lens is configured to converge, on the optical receiving apparatus, an echo optical signal reflected by an object. The optical receiving apparatus is configured to convert the echo optical signal into an echo electrical signal. The processor is configured to: analyze the echo electrical signal, and control the light source, the scanner, and the optical receiving apparatus. The light detection and ranging system has a large dynamic range and high detection efficiency.

According to a third aspect, an embodiment of this disclosure provides a detection method, applied to the light detection and ranging system, including: outputting a control signal to a light source, to drive the light source to output a laser beam; outputting a control signal to a scanner, to drive the scanner to perform scanning in a specified mode; and receiving an echo signal output by an optical receiving apparatus, processing the echo signal, and obtaining object information corresponding to an echo. In this way, a dynamic range of detection is increased, and detection efficiency is improved.

### BRIEF DESCRIPTION OF DRAWINGS

FIG. 1 is a schematic diagram of a structure of a light detection and ranging system according to an embodiment of this disclosure;

FIG. 2 is a schematic diagram of a photosensitive surface of a SiPM detector according to an embodiment of this disclosure;

FIG. 3 is a schematic diagram of a relationship between a beam homogenization unit and a SiPM detector according to an embodiment of this disclosure;

FIG. 4 is a schematic diagram in which a beam homogenization unit fits a SiPM detector according to an embodiment of this disclosure;

FIG. 5 is a schematic diagram of a structure of a beam homogenization unit according to an embodiment of this disclosure;

FIG. 6 is a schematic diagram of light reflection of a beam homogenization prism according to an embodiment of this disclosure;

FIG. 7 is a schematic diagram in which beam homogenization units are embraced and fastened by using a mechanical part according to an embodiment of this disclosure;

FIG. 8 is a schematic diagram of a scanning and detection method according to an embodiment of this disclosure;

FIG. 9 is a schematic diagram in which beam homogenization prisms are combined according to an embodiment of this disclosure;

FIG. 10 is a schematic three-dimensional diagram of a cylindrical microlens according to an embodiment of this disclosure;

FIG. 11 is a schematic diagram in which an edge gap exists between photosensitive surfaces of a detector according to an embodiment of this disclosure;

FIG. 12 is a schematic diagram of a structure of a beam homogenization unit corresponding to FIG. 11 according to an embodiment of this disclosure;

FIG. 13 is a schematic diagram of an optical path of an optical receiving apparatus that does not include a beam homogenization prism according to an embodiment of this disclosure;

FIG. 14 is a schematic diagram of receiving an echo photon corresponding to FIG. 13 according to an embodiment of this disclosure;

FIG. 15 is a schematic diagram of an optical path of an optical receiving apparatus that includes a beam homogenization prism according to an embodiment of this disclosure; and

FIG. 16 is a schematic diagram of receiving an echo photon corresponding to FIG. 15 according to an embodiment of this disclosure.

### DESCRIPTION OF EMBODIMENTS

To make the objectives, technical solutions, and advantages of this disclosure clearer, the following further describes implementations of this disclosure in detail with reference to accompanying drawings.

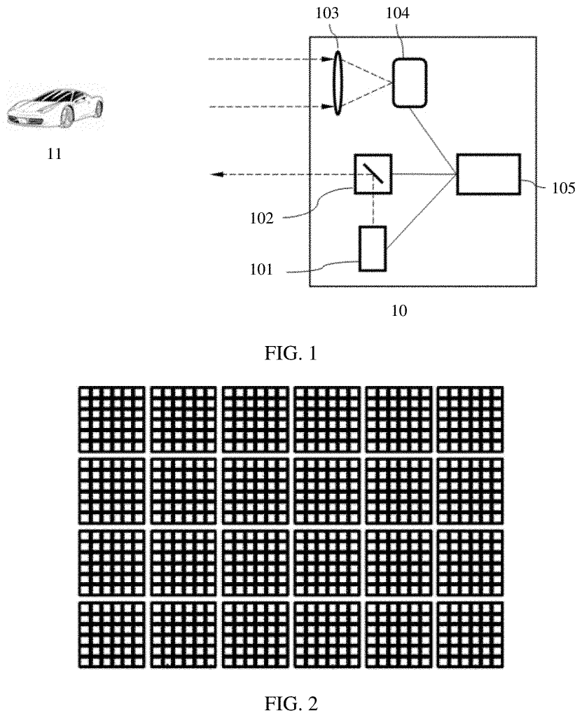

An embodiment of this disclosure provides an optical receiving apparatus, and a light detection and ranging system to which the optical receiving apparatus is applied. As shown in FIG. 1, a light detection and ranging system 10 includes a light source 101, a scanner 102, a receiving lens 103, an optical receiving apparatus 104, and a processor 105.

The light source 101 is configured to output a laser beam.

The scanner 102 is configured to perform two-dimensional scanning in a specified region.

The receiving lens 103 is configured to converge, on the optical receiving apparatus 104, an echo optical signal reflected by an object 11.

The optical receiving apparatus 104 is configured to convert the echo optical signal into an echo electrical signal.

The processor 105 is configured to: control the light source 101, the scanner 102, and the optical receiving apparatus 104, and analyze the echo electrical signal to obtain a related parameter of the object 11. After two-dimensional scanning is completed, the processor 105 finally obtains a point cloud image through an analysis.

The optical receiving apparatus 104 includes a photodetector, the photodetector may be a silicon photomultiplier (SiPM). The SiPM includes a plurality of pixels, and the pixels usually form a two-dimensional pixel array, for example, M*N pixels, where M and N are positive integers greater than 1. Each pixel includes a plurality of cells, and each cell is an independent photosensitive unit (cell), and is configured to convert a received optical signal into an electrical signal. Electrical signals of a plurality of cells included in one pixel are accumulated and output through a common output channel.

An example of the SiPM detector is shown in FIG. 2. The SiPM detector includes 6*4 pixels, and each pixel includes 6*6 pixels. To complete a point cloud image of 1440*900 pixels, for a SiPM detector of 6*4 pixels, the scanner needs to perform scanning by setting 240 angles in a horizontal direction and setting 225 angles in a vertical direction, to finally form a complete point cloud image.

The optical receiving apparatus 104 further includes a plurality of beam homogenization units, and each beam homogenization unit corresponds to one pixel of the photodetector. The beam homogenization unit is configured to diffuse the received echo optical signal to a plurality of cells included in a corresponding pixel.

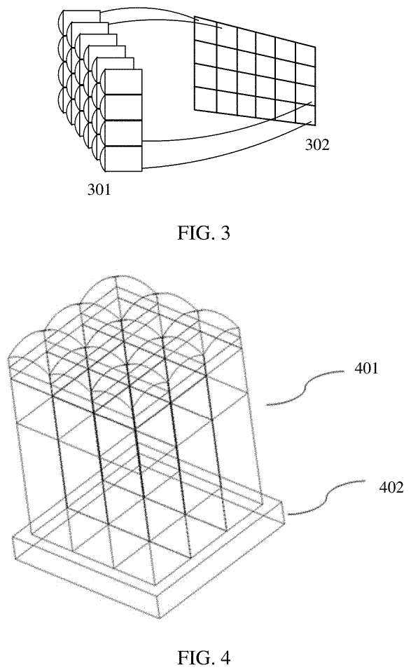

As shown in FIG. 3, the optical receiving apparatus includes 6*4 beam homogenization units (301), and the 24 beam homogenization units respectively correspond to 6*4 pixels (302) of the photodetector. In an actual product, a light-emitting surface of the beam homogenization unit usually fits a photosensitive surface of the SiPM detector.

FIG. 4 is a schematic diagram in which a beam homogenization unit fits a SiPM detector. For clarity, the photodetector in the figure includes 3*3 pixels, there are nine beam homogenization units 401, and the nine beam homogenization units 401 are in a one-to-one correspondence with the 9 pixels of the SiPM detector 402.

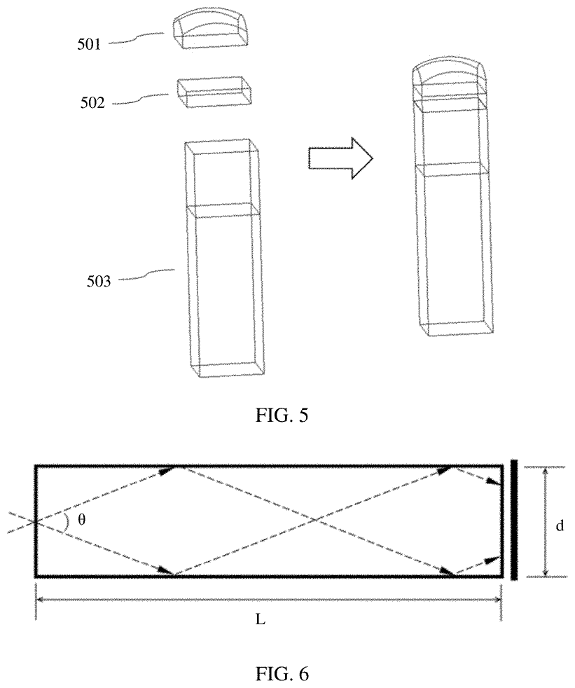

As shown in FIG. 5, a structure of the beam homogenization unit provided in this embodiment of this disclosure includes a microlens 501, a diffusion sheet 502, and a beam homogenization prism 503. The microlens 501, the diffusion sheet 502, and the beam homogenization prism 503 may be fixedly connected through bonding by using a photosensitive adhesive, to form a beam homogenization unit, as shown on a right side in FIG. 5.

The microlens 501 is configured to receive an echo incident light beam and converge the incident light beam on the diffusion sheet. The microlens may be used to enlarge a receiving numerical aperture, so that a light beam at a larger angle of incidence can enter the optical receiving apparatus. For example, a radius of spherical surface curvature of the microlens may be designed to be 1.4 mm and a thickness of 1 mm Therefore, the receiving numerical aperture is approximately 0.25. A material of the microlens may be BK7 glass, or the like.

The diffusion sheet 502 is configured to diffuse the received incident light beam. A divergence angle of a light beam entering the diffusion sheet through the microlens is enlarged by the diffusion sheet, to rapidly diffuse the light beam in the beam homogenization prism, and reduce a length of the beam homogenization prism.

A side wall of the beam homogenization prism 503 is usually coated with a reflective coating, so that the light beam passing through the diffusion sheet is further diffused to a plurality of cells of a corresponding pixel of the photodetector. The beam homogenization prism has a beam homogenization function: The light beam enters the beam homogenization prism. A “photon well” is formed because the side wall of the beam homogenization prism is coated with the reflective coating. When the light beam is reflected for a plurality of times in the well, and arrives at the photosensitive surface of the photodetector SiPM, energy is evenly distributed. Because of the reflective coating, a photon cannot pass through the prism to arrive at an adjacent beam homogenization unit, to avoid crosstalk.

A light-passing cross section of the beam homogenization prism may be rectangular, and is usually square. FIG. 6 is a schematic diagram of light reflection of a beam homogenization prism. In FIG. 6, the length of the beam homogenization prism is L, and a side length of a cross-sectional square is d. Herein, d is usually the same size as or slightly greater than a size of a pixel of the corresponding SiPM detector, so that all light beams arrive at the photosensitive surface of the SiPM.

The length L of the beam homogenization prism may be designed based on the following condition: L≥d/(2*tan(θ/2)). Herein, d is a length of a shortest side of the light-passing cross section of the prism, and θ is the divergence angle existing when the light beam enters the prism. For example, in an embodiment, a size of each pixel of the detector is 1 mm*1 mm, and a size of a light-passing surface of each beam homogenization unit is 1 mm*1 mm. In other words, d=1 mm.

The side wall of the beam homogenization prism may be coated with the reflective coating. An upper end face, a lower end face, a light-entrance end face, and a light-exit end face may be coated with an anti-reflective coating, and light-passing surfaces of the microlens and the diffusion sheet may be coated with an anti-reflective coating. An operating end face of the microlens may be further polished.

The optical receiving apparatus may include M*N beam homogenization units, and the M*N beam homogenization units correspond to M*N pixels of the photodetector. The beam homogenization units may be combined together in some common fastening manners, for example, may be bonded by using the photosensitive adhesive.

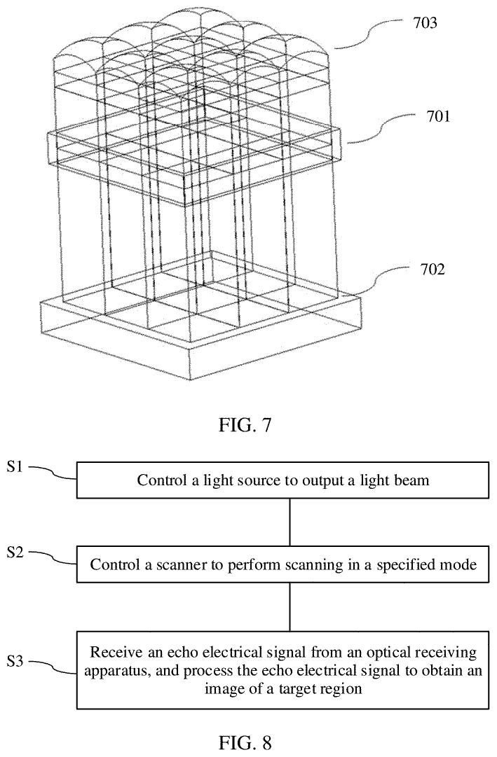

The beam homogenization units may alternatively be embraced and fastened by using a mechanical part. As shown in FIG. 7, 3*3 beam homogenization units are fastened by using one mechanical part 701, so that the entire optical receiving apparatus is not easily deformed, and detection performance is more stable.

A light-emitting surface of each beam homogenization unit needs to cover an effective photosensitive surface of a corresponding pixel, and a size of the light-emitting surface is the same as a size of the corresponding pixel, or is the same as a size of the effective photosensitive surface of the corresponding pixel. An exit end fits the photosensitive surface of the SiPM, to ensure that an exit does not leak light.

When the optical receiving apparatus is assembled, the light-emitting surface of the beam homogenization unit needs to be aligned with the photosensitive surface of the pixel of the SiPM detector. A possible assembly method is as follows:

Step 1: Fit the light-emitting end face of the beam homogenization unit and the photosensitive surface of the SiPM detector without applying an adhesive.

Step 2: Irradiate a light-entrance port of any beam homogenization unit of the optical receiving apparatus by using a fine light beam of an operating band of the SiPM detector, monitor an output amplitude of a response signal of a corresponding pixel of the SiPM detector, adjust a location of the beam homogenization unit upward, downward, leftward, and rightward, and fasten the location of the beam homogenization unit when an output signal of the SiPM detector has a maximum amplitude.

Step 3: Apply the photosensitive adhesive around a fitting part of the beam homogenization unit and the SiPM detector, so that the photosensitive adhesive and the SiPM detector are bonded together after the adhesive is dried. In FIG. 7, a location shown in 702 is the fitting part of the beam homogenization unit and the SiPM detector.

In the light detection and ranging system shown in FIG. 1, a light-entrance surface of the optical receiving apparatus 104 is a light-entrance surface 703 of the beam homogenization unit shown in FIG. 7, and needs to be placed on a focal plane of the receiving lens 103, to avoid photo crosstalk at an entrance end.

Corresponding to the light detection and ranging system shown in FIG. 1, an embodiment of this disclosure further provides a scanning and detection method of a light detection and ranging system. As shown in FIG. 8, the method includes the following steps.

S1: A processor 105 outputs a control signal to a light source 101, to drive the light source to output a laser beam. An output end of the light source 101 may further include an emitting lens, so that a transmit light beam is shaped into a spot light beam, and then enters a scanner 102.

S2: The processor 105 outputs a control signal, for example, information such as a scanning angle, to the scanner 102, to drive the scanner to perform scanning in a specified mode.

In this way, the light beam output by the light source passes through the scanner and is transmitted to a target region.

S3: The processor 105 receives an echo signal, performs processing, and obtains information such as an angle and a distance of an object corresponding to a current echo. The light beam output from the scanner 102 encounters an object and is reflected, to transmit an echo light beam to the light detection and ranging system. The echo light beam is converged by a receiving lens 103, and enters an optical receiving apparatus 104. After passing through the beam homogenization unit, the light beam irradiates a photosensitive pixel of a SiPM detector. After photoelectric conversion, an echo electrical signal is output, and the processor receives the echo electrical signal for processing.

The processor 105 continues the process, and performs two-dimensional scanning in the target region, to form a point cloud image of the target region.

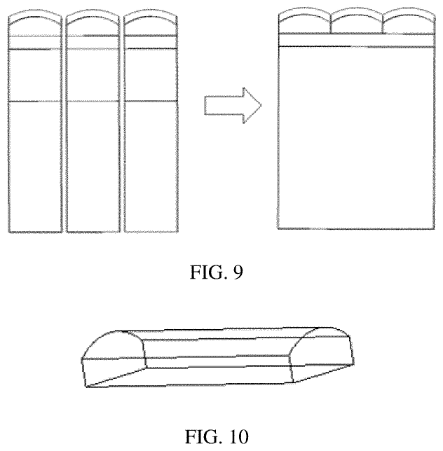

In some actual applications, a plurality of beam homogenization units may be combined to form a row layout, a column layout, or an irregular-shape layout. For example, as shown in FIG. 9, beam homogenization prisms of three regular cubes are combined to form a cuboid beam homogenization prism, and correspond to 1*3 pixels of the SiPM detector. A combination method is: combining three beam homogenization prisms with optical path isolation, to form a prism without internal isolation. Further, three spherical microlens groups shown in FIG. 9 may further form one cylindrical microlens. FIG. 10 is a stereogram of a cylindrical microlens.

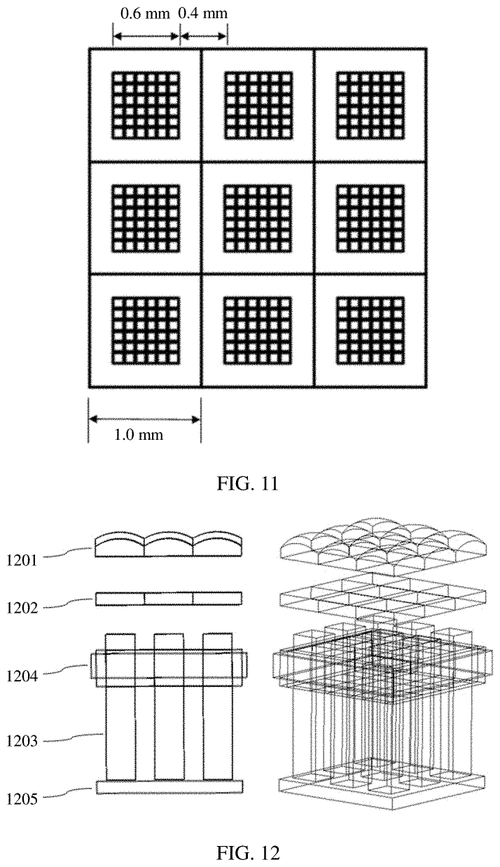

An embodiment of this disclosure further provides an optical receiving apparatus, applied to an array SiPM detector having a low pixel fill factor. As shown in FIG. 11, an edge gap exists between photosensitive surfaces in pixels of the detector. In the figure, a size of each pixel of the detector is 1.0 mm*1.0 mm, a size of a photosensitive surface of each pixel is 0.6 mm*0.6 mm, a width of an edge gap between pixels is 0.4 mm, and the fill factor is 60%.

Correspondingly, a structure of a beam homogenization unit is shown in FIG. 12. In the figure, a test diagram is on a left side, and a stereogram is on a right side. The beam homogenization unit includes a microlens 1201, a diffusion sheet 1202, a beam homogenization prism 1203, a fastening mechanical part 1204, and a SiPM detector 1205. It can be learned from the figure that, a size of a light-emitting surface of the beam homogenization prism is reduced to a size the same as a size of the photosensitive surface of the detector. In this way, all photons received by a light-entrance end face can be introduced to the photosensitive surface in the pixel, to improve light energy utilization. It is equivalent to increase the fill factor of the detector from 60% to 100%.

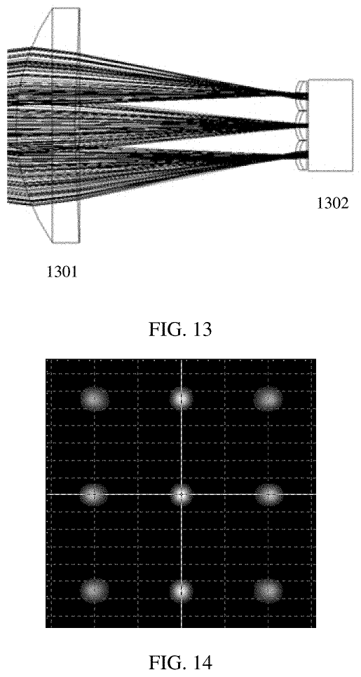

The following describes an example technical effect of embodiments of this disclosure. FIG. 13 is a diagram of an optical path of an optical receiving apparatus to which no beam homogenization prism is added. After passing through a receiving prism 1301, an echo light ray is focused within a local range of a photosensitive surface of a SiPM detector with 3*3 pixels. Only a small part of each pixel, namely, a small quantity of cells, can receive an echo photon. FIG. 14 is a schematic diagram of receiving a corresponding echo photon. It can be learned that all echo photons are focus in a center of the 3*3 pixels.

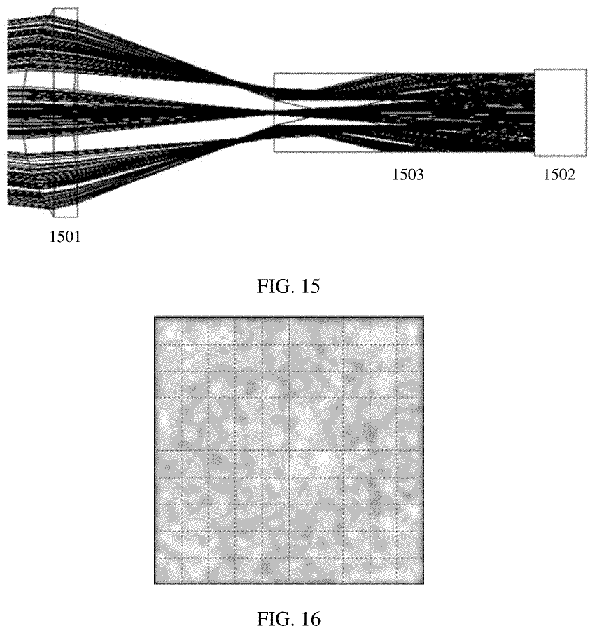

FIG. 15 is a diagram of an optical path of an optical receiving apparatus to which a beam homogenization prism is added. A 3*3 beam homogenization prism 1503 is added before a SiPM detector 1502 with 3*3 pixels. After passing through a receiving prism 1501, an echo light ray is focused on a light-entrance surface of the homogenization prism. After the echo light ray is reflected by a side wall of the beam homogenization prism for a plurality of times, the echo light ray is evenly distributed on a photosensitive surface of the 3*3 pixels. In other words, all cells in a pixel can receive an echo photon more evenly. FIG. 16 is a schematic diagram of receiving a corresponding echo photon. It can be learned that all echo photons are evenly distributed on the 3*3 pixels.

The optical receiving apparatus including the beam homogenization unit may also be used in a product such as a security camera and a micro-light detection and imaging device. The product needs to detect a weak optical signal, and a better image may be obtained by using an array SiPM detector.

Although this disclosure is described with reference to embodiments, in a process of implementing this disclosure that claims protection, persons skilled in the art may understand and implement another variation of the disclosed embodiments by viewing the accompanying drawings, disclosed content, and the appended claims. In the claims, “comprising” does not exclude another component or another step, and “a” or “one” does not exclude a case of multiple.

Although this disclosure is described with reference to a specific feature and embodiments thereof, it is apparent that various modifications and combinations thereof may be made. Correspondingly, this specification and the accompanying drawings are merely example description of this disclosure defined by the appended claims, and are considered as any or all of modifications, variations, combinations or equivalents that cover the scope of this disclosure. It is clear that a person skilled in the art can make various modifications and variations to this disclosure without departing from the scope of this disclosure. This disclosure is intended to cover these modifications and variations provided that they fall within the scope of protection defined by the following claims and their equivalent technologies.

What is claimed is:

1. An optical receiving apparatus, comprising a photodetector and a plurality of beam homogenization units, wherein
the photodetector comprises a plurality of pixels, each pixel of the plurality of pixels comprises a plurality of cells, and each cell of the plurality of cells is configured to convert a received optical signal into an electrical signal; and
each beam homogenization unit of the plurality of beam homogenization units is configured to correspond to at least one pixel of the photodetector and to diffuse a received incident light beam to a plurality of cells comprised in the corresponding at least one pixel.

2. The optical receiving apparatus according to claim 1, wherein the each beam homogenization unit comprises a beam homogenization prism; and
a side wall of the beam homogenization prism is coated with a reflective coating, so that the received incident light beam is diffused to the plurality of cells comprised in the corresponding at least one pixel.

3. The optical receiving apparatus according to claim 2, wherein a length L of the beam homogenization prism satisfies a condition: L≥d/(2*tan(θ/2)), wherein d is a length of a short side of a light-passing cross section of the beam homogenization prism, and θ is a divergence angle existing when a light beam enters the beam homogenization prism.

4. The optical receiving apparatus according to claim 2, wherein the each beam homogenization unit further comprises a diffusion sheet disposed before a light-entrance surface of the beam homogenization prism; and the diffusion sheet is configured to diffuse and output the received incident light beam to the light-entrance surface.

5. The optical receiving apparatus according to claim 2, wherein the each beam homogenization unit further comprises a microlens, disposed on a light-entrance surface of the each beam homogenization unit; and the microlens is configured to converge the received incident light beam on a diffusion sheet or a light-entrance surface of the beam homogenization prism.

6. The optical receiving apparatus according to claim 1, wherein components of the beam homogenization unit are connected through bonding by using a photosensitive adhesive.

7. The optical receiving apparatus according to claim 1, wherein the photodetector is a silicon photomultiplier (SiPM).

8. The optical receiving apparatus according to claim 1, wherein two or more beam homogenization units of the plurality of beam homogenization units are embraced and fastened by using a mechanical part.

9. The optical receiving apparatus according to claim 1, wherein the each beam homogenization unit is configured to correspond to two or more pixels of the plurality of pixels, and wherein the plurality of beam homogenization units are a prism without internal isolation, and form a row layout, a column layout, or an irregular-shape layout.

10. The optical receiving apparatus according to claim 1, wherein a light-emitting surface of the each beam homogenization unit has a same size as a photosensitive surface in the corresponding at least one pixel.

11. A light detection and ranging system, comprising a light source, a scanner, a receiving lens, the optical receiving apparatus, wherein
the light source is configured to output a laser beam;
the scanner is configured to perform scanning in a specified region;
the receiving lens is configured to converge, on the optical receiving apparatus, an echo optical signal reflected by an object;
the optical receiving apparatus, comprising a photodetector and a plurality of beam homogenization units, wherein the photodetector comprises a plurality of pixels, each pixel of the plurality of pixels comprises a plurality of cells, and each cell of the plurality of cells is configured to convert a received optical signal into an electrical signal; and each beam homogenization unit of the plurality of beam homogenization units is configured to correspond to at least one pixel of the photodetector and to diffuse a received incident light beam to a plurality of cells comprised in the corresponding at least one pixel.

12. The light detection and ranging system according to claim 11, wherein the each beam homogenization unit comprises a beam homogenization prism; and
a side wall of the beam homogenization prism is coated with a reflective coating, so that the received incident light beam is diffused to the plurality of cells comprised in the corresponding at least one pixel.

13. The light detection and ranging system according to claim 12, wherein a length L of the beam homogenization prism satisfies a condition: L≥d/(2*tan(θ/2)), wherein d is a length of a short side of a light-passing cross section of the beam homogenization prism, and θ is a divergence angle existing when a light beam enters the beam homogenization prism.

14. The light detection and ranging system according to claim 12, wherein the each beam homogenization unit further comprises a diffusion sheet disposed before a light-entrance surface of the beam homogenization prism; and the diffusion sheet is configured to diffuse and output the received incident light beam to the light-entrance surface.

15. The light detection and ranging system according to claim 12, wherein the each beam homogenization unit further comprises a microlens, disposed on a light-entrance surface of the each beam homogenization unit; and the microlens is configured to converge the received incident light beam on a diffusion sheet or a light-entrance surface of the beam homogenization prism.

16. The light detection and ranging system according to claim 11, wherein components of the beam homogenization unit are connected through bonding by using a photosensitive adhesive.

17. The light detection and ranging system according to claim 11, wherein the photodetector is a silicon photomultiplier (SiPM).

18. The light detection and ranging system according to claim 11, wherein two or more beam homogenization units of the plurality of beam homogenization units are embraced and fastened by using a mechanical part.

19. The light detection and ranging system according to claim 11, wherein the each beam homogenization unit is arranged to correspond to two or more pixels of the plurality of pixels, and wherein the plurality of beam homogenization units are a prism without internal isolation, and form a row layout, a column layout, or an irregular-shape layout.

20. The light detection and ranging system according to claim 11, wherein a light-emitting surface of the each beam homogenization unit has a same size as a photosensitive surface in the corresponding at least one pixel.
